(19) United States
(12) Patent Application Publication
(10) Pub. No.: US 2026/0127902 A1
(43) Pub. Date: May 7, 2026

(54) TEXT READABILITY PREDICTION DEVICE AND TEXT READABILITY PREDICTION METHOD

(71) Applicant: National Taiwan University of Science and Technology, Taipei City (TW)

(72) Inventors: Hou-Chiang TSENG, Taoyuan City (TW); Kuan-Yu CHEN, New Taipei City (TW); Yao-Ting SUNG, Taipei City (TW); Berlin CHEN, New Taipei City (TW); Chieh-Hsuan WU, Taoyuan City (TW)

(21) Appl. No.: 19/250,028

(22) Filed: Jun. 25, 2025

Related U.S. Application Data
(60) Provisional application No. 63/714,874, filed on Nov. 1, 2024.

(30) Foreign Application Priority Data
Feb. 12, 2025 (TW) 114105237

(51) Int. Cl. G06V 20/70; G06F 40/40; G06T 11/60; G06V 10/764; G06V 10/774; G06V 10/82; G06V 20/62; G06V 30/262; G06V 30/413; G06V 30/416

(52) U.S. Cl. CPC G06V 20/70; G06F 40/40; G06T 11/60; G06V 10/764; G06V 10/7747; G06V 10/82; G06V 20/62; G06V 30/274; G06V 30/413; G06V 30/416

(57) ABSTRACT

A text readability prediction device and method are provided. The text readability prediction device segments a picture and a text corresponding to the picture from a data to be determined. The text readability prediction device sends a prompt, the picture and the text corresponding to the picture to at least one multimodal large language model to generate a picture semantic corresponding to the picture. The text readability prediction device sends a readability feature to a readability model to predict a readability of the data to be determined.

### CROSS-REFERENCE TO RELATED APPLICATION

This application claims priority to Taiwan Application Serial Number 114105237, filed Feb. 12, 2025, and U.S. Provisional Application Ser. No. 63/714,874, filed Nov. 1, 2024, all of which are herein incorporated by reference in their entireties.

### BACKGROUND

### FIELD OF INVENTION

The present disclosure relates to a text readability prediction device and a method. More particularly, the present disclosure relates to a readability prediction device and method capable of predicting the readability of data containing text and pictures.

### Description of Related Art

In recent years, various readability prediction technologies and applications have been proposed one after another. In the prior art, the readability of the input data is generally predicted by simply analyzing the text semantics corresponding to the input data.

However, conventional text readability prediction models are limited to predicting readability of words and are unable to simultaneously consider the content of the picture itself for readability prediction. As a result, the text readability prediction model is limited in its ability to “understand pictures” and cannot further improve the versatility and accuracy of the readability model.

For the foregoing reasons, there is a need for providing a device and a method capable of automatically understanding semantics of an picture and combining it with text content to predict text readability to solve the above problems encountered in related art approaches.

### SUMMARY

One aspect of the present disclosure provides a text readability prediction device. The text readability prediction device includes a transceiver interface, a storage and a processor. The transceiver interface is configured to receive a data to be determined. The storage is configured to store at least one multimodal large language model and a readability model. The processor is electrically connected to the transceiver interface and the storage. The processor is configured to segment a picture and a text corresponding to the picture from the data to be determined. The processor is configured to send a prompt, the picture and the text corresponding to the picture to the at least one multimodal large language model to generate a picture semantics corresponding to the picture, where the prompt is configured to indicate a generated type of the picture semantics. The processor is configured to send a readability feature to the readability model to predict a readability corresponding to the data to be determined, where the readability feature is generated according to the text corresponding to the picture and the picture semantics corresponding to the picture.

Another aspect of the present disclosure provides a method. The method is adapted to an electronic device. The method includes following steps of: segmenting a picture and a text corresponding to the picture from a data to be determined; sending a prompt, the picture and the text corresponding to the picture to the at least one multimodal large language model to generate a picture semantics corresponding to the picture, wherein the prompt is configured to indicate a generated type of the picture semantics; and sending a readability feature to a readability model to predict a readability corresponding to the data to be determined, wherein the readability feature is generated according to the text corresponding to the picture and the picture semantics corresponding to the picture.

The technology provided by the present disclosure (at least including a text readability prediction device and method) is to segment a picture and a text corresponding to the picture from the data to be determined. Then, the present disclosure is configured to generate picture semantics corresponding to the picture according to a multimodal large language model. Finally, the present disclosure is configured to send the readability feature to the readability model to predict a readability corresponding to the data to be determined. The present disclosure is configured to generate picture semantics of the corresponding to the picture through the multimodal large language model, and combines the text and the picture semantics. Therefore, the technology provided by the present disclosure increases a comprehensive understanding ability of a readability prediction device for text and pictures, and also improves an accuracy of readability prediction.

### BRIEF DESCRIPTION OF THE DRAWINGS

The present disclosure can be more fully understood by reading the following detailed description of the embodiment, with reference made to the accompanying drawings as follows:

FIG. 1 depicts a schematic diagram of a text readability prediction device according to a first embodiment of the present disclosure;

FIG. 2 depicts a schematic diagram of a storage according to a first embodiment of the present disclosure;

FIG. 3 depicts a schematic diagram of data segmentation according to a first embodiment of the present disclosure;

FIG. 4 depicts a schematic diagram of data segmentation according to some embodiments of the present disclosure; and

FIG. 5 depicts a flow chart of a text readability prediction method according to a second embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The terminology used herein is for the purpose of describing particular example embodiments only and is not intended to be limiting of the present disclosure. As used herein, the singular forms “a,” “an” and “the” are intended to include the plural forms as well, unless the context clearly indicates otherwise.

Furthermore, it should be understood that the terms, “comprising”, “including”, “having”, “containing”, “involving” and the like, used herein are open-ended, that is, including but not limited to.

The terms used in this specification and claims, unless otherwise stated, generally have their ordinary meanings in the art, within the context of the disclosure, and in the specific context where each term is used. Certain terms that are used to describe the disclosure are discussed below, or elsewhere in the specification, to provide additional guidance to the practitioner skilled in the art regarding the description of the disclosure.

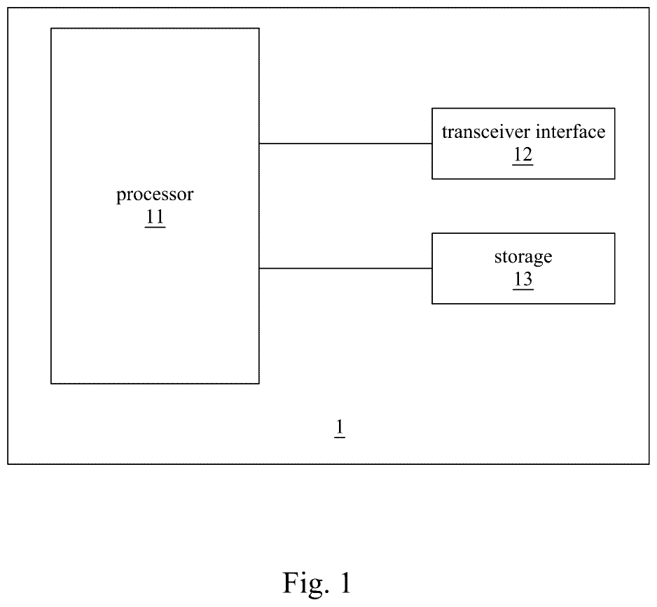

A first embodiment of a text readability prediction device of the present disclosure is shown in FIG. 1. As shown in FIG. 1, the text readability prediction device 1 includes a processor 11, a transceiver interface 12 and a storage 13. The processor 11 is electrically connected to the transceiver interface 12 and the storage 13. The transceiver interface 12 is configured to receive a data to be determined. The data to be determined may be reading materials (e.g.,: picture books, storybooks)consisting of at least articles and pictures. In addition to articles and pictures, the data to be determined may further include information such as titles, notes, page numbers or background pictures.

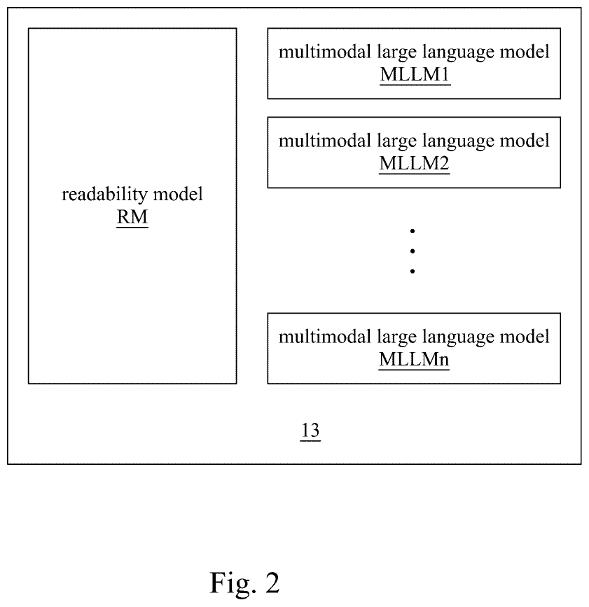

As shown in FIG. 2, the storage 13 is configured to store at least one multimodal large language model MLLM1, MLLM2, . . . , MLLMn and a readability model RM, where n is a positive integer. Each of the multimodal large language models MLLM1, MLLM2, . . . , MLLMn is a large language model that can simultaneously receive multiple forms of input data (e.g.,: words, images, audio, and video), and the multimodal large language models MLLM1, MLLM2, . . . , MLLMn can generate an output result corresponding to an input prompt according to the input prompt. The readability model RM is a model that can analyze and predict the readability of articles (e.g.,: SVM, Bayes classifier, linear regression model, decision tree regression model and other classification models or regression models).

It should be noted that FIG. 2 is only for illustration purposes, and the present disclosure does not limit a number of the multimodal large language model MLLM1, MLLM2, . . . , MLLMn stored in the storage 13. The number can be designed according to actual needs of the text readability prediction device 1. In this embodiment, the text readability prediction device 1 at least includes one or more multimodal large language models (i.e., at least one multimodal large language model).

It should be noted that the transceiver interface 12 is an interface capable of receiving and transmitting data or other interfaces capable of receiving and transmitting data known to a person having ordinary knowledge in the technical field to which the present disclosure belongs. The transceiver interface 12 can receive data from sources such as external devices, external web pages, external applications, etc. The processor 11 can be any processing unit, central processing unit (CPU), microprocessor or other computing device known to those skilled in the art. The storage 13 can be a memory, a USB disk, a hard disk, an optical disk, a flash drive, or any other storage medium or circuit having the same function known to a person skilled in the art.

In the present disclosure, a readability of a data to be determined is mainly predicted according to the readability model RM. The following paragraphs will describe in detail the implementation details related to the present disclosure.

In this embodiment, the text readability prediction device 1 is configured to perform text and picture analysis and readability prediction. The present disclosure needs to segment a data to be predicted (i.e., a picture and a text corresponding to the picture) from the data to be determined. The data to be determined can include information such as title, text, illustrations or page numbers.

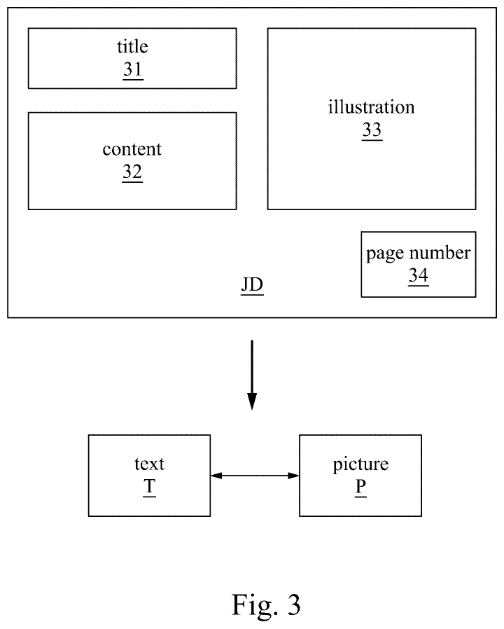

For example, please refer to a data segmentation diagram in FIG. 3. As shown in FIG. 3, the processor 11 is configured to analyze a data to be determined JD to determine pieces of object data in the data to be determined JD, which includes a title 31, a content 32, an illustration 33 and a page number 34, and the processor 11 is configured to segment a picture P and a text T corresponding to the picture P from the data to be determined JD.

Specifically, the processor 11 is configured to segment the picture P and the text T corresponding to the picture P from the data to be determined JD.

In some embodiment, the processor 11 is configured to analyze pieces of object data on the data to be determined JD to generate a data tag (e.g.,: a text tag, a picture tag, a note tag) corresponding to each of the pieces of object data, where the data tags indicate the nature of the pieces of object data, and a plurality of pieces of target object data are selected from the pieces of object data according to contents of the target data tags (e.g.,: a text tag, a picture tag) of the data tags. Finally, the pieces of target object data are segmented from the pieces of object data to serve as input data of the readability model RM.

For ease of understanding, please refer to the data segmentation diagram in FIG. 3. As shown in FIG. 3, the processor 11 is configured to analyze pieces of object data in the data to be determined JD. The pieces of object data include the title 31, the content 32, the illustration 33 and the page number 34. For example, the processor 11 is configured to analyze pieces of object data and determine that data tags of the title 31 and the content 32 correspond to a text tag, a data tag of the illustration 33 corresponds to a picture tag, and a data tag of the page number 34 corresponds to a note tag. Then, a target data tag is set as a text tag and a picture tag, and the processor 11 is configured to select the title 31, the content 32 and the illustration 33 from the pieces of object data as pieces of target object data. In other words, the data tag (i.e., the note tag) corresponding to the page number 34 does not belong to the target data tag, so the processor 11 does not be configured to select the page number 34 as the pieces of target object data.

Finally, the processor 11 is configured to perform segmentation of the pieces of target object data. The processor 11 is configured to segment the illustration 33 as the picture P, and segment the title 31 and the content 32 as the text T corresponding to the picture P. It should be noted that the processor 11 is configured to concatenate words of the title 31 and the content 32 through punctuation marks to generate the text T corresponding to the picture P.

It should be noted that the processor 11 can be configured to analyze the pieces of object data through an artificial intelligence model (for example, a classifier using a convolutional neural network, a character recognition model) to generate data tags corresponding to the pieces of object data.

Specifically, the processor 11 is configured to analyze the pieces of object data on the data to be determined JD to generate a data tag corresponding to each of the pieces of object data. Then, the processor 11 is configured to select a plurality of pieces of target object data corresponding to a plurality of target data tags from the pieces of object data according to the target data tags of the data tags, where the target data tags include a picture tag and a text tag. Finally, the processor 11 is configured to segment the pieces of target object data from the pieces of object data to serve as the picture P and the text T corresponding to the picture P.

In this embodiment, the processor 11 is configured to send a prompt, the picture P and the text T corresponding to the picture P to at least one multimodal large language model MLLM1, MLLM2, . . . , MLLMn to generate a picture semantics corresponding to the picture P. The prompt is configured to indicate a generated type (e.g.,: a format, a tone, a word difficulty, a language, etc) of the picture semantics corresponding to the picture P.

For example, the processor 11 is configured to send a prompt, the picture P and the text T corresponding to the picture P to a multimodal large language model MLLMn. Content of the prompt is “Please generate a description corresponding to the picture according to the input content of the text and the picture, where the tone and the word difficulty of the description must be the same as the text content”. The prompt is configured to indicate that a generated type of the picture semantics is “The tone and the word difficulty of the description must be the same as the text content. ”. Finally, the multimodal large language model MLLMn is configured to generate a picture semantics corresponding to the picture P.

For another example, content of the prompt is “Please generate a description corresponding to the picture according to the input content of the text and the picture, where a description format must start with a subject, be modified by an adjective, and finally be modified by a verb. ”. The prompt is configured to indicate that a generated type of the picture semantics is “a description format must start with a subject, be modified by an adjective, and finally be modified by a verb”. Finally, the multimodal large language model MLLMn is configured to generate a picture semantics corresponding to the picture P.

It should be noted that by clearly indicating the generated type of picture semantics in the content of the prompt, the generated picture semantics can be made more unified (e.g.,: a unified format), or the generated picture semantics can be made more consistent with the nature of the text (e.g.,: the tone, the word difficulty), thereby increasing an accuracy of the readability model RM.

It should be noted that the prompt can be generated according to an artificial intelligence prompt generator. In some embodiment, the prompt can be further generated according to a user input.

It should be noted that a content represented by picture P may have different meanings from a content described by text T. For example, the content of the text T is “The Anglo-French War was a major war in the Middle Ages”. The picture P is a diagram with the content “soldiers in armor holding weapons and fighting”. Readers cannot learn “types of weapon used by the soldiers in the war” or “the appearance of armor worn by soldiers” by reading the content of the text T. This embodiment simultaneously understands the content of the text T and the image P to improve the readability prediction capability.

Specifically, the processor 11 is configure to send a prompt, the picture P and the text T corresponding to the picture P to the at least one multimodal large language model MLLM1, MLLM2, . . . , MLLMn to generate a picture semantics corresponding to the picture P, where the prompt is configured to indicate a generated type of the generated picture semantics.

In some embodiment, the at least one multimodal large language model MLLM1, MLLM2, . . . , MLLMn at least include a first large language model and a second large language model. The processor 11 can be configured to generate a first candidate picture description and a second candidate picture description corresponding to the picture P through the first large language model and the second large language model. Then, the first candidate picture description and the second candidate picture description are combined to generate the picture semantics corresponding to the picture P.

For example, the first candidate picture description and the second candidate picture description can be combined in a concatenated manner. It is also possible to instruct a generative large language model to combine the first candidate picture description and the second candidate picture description through the prompt according to the generative large language model.

Specifically, the processor 11 is configured to send the prompt, the picture P and the text T corresponding to the picture P to the first large language model to generate a first candidate picture description corresponding to the picture P. Then, the processor 11 is configured to send the prompt, the picture P and the text T corresponding to the picture P to the second large language model to generate a second candidate picture description corresponding to the picture P. Finally, the processor 11 is configured to combine the first candidate picture description corresponding to the picture P and the second candidate picture description corresponding to the picture P to generate the picture semantics corresponding to the picture P.

In this embodiment, processor 11 is configured to generate a readability feature according to the text T corresponding to the picture P and the picture semantics corresponding to the picture P, and predict a readability of the data to be determined JD according to the readability model RM.

Specifically, the processor 11 is configured to send a readability feature to the readability model RM to predict a readability corresponding to the data to be determined JD, where the readability feature is generated according to the text T corresponding to the picture P and the picture semantics corresponding to the picture P.

In some embodiment, the processor 11 is configured to combine the text T corresponding to the picture P and the picture semantics corresponding to the picture P to generate a combined text, and the combined text is composed of a plurality of unit texts (e.g.: a sentence is composed of a plurality of words). Then, unit text vectors of the unit texts are calculated through a language model and the unit text vectors are combined to generate the readability feature.

For example, the text T corresponding to the picture P and the picture semantics corresponding to the picture P can be combined in a concatenated manner. It is also possible to instruct a generative large language model to combine the text T corresponding to the picture P and the picture semantics corresponding to the picture P through the prompt according to the generative large language model.

It should be noted that the language model can be a language model that can convert words into vectors, such as Word2vec, GloVe, or BERT.

Specifically, the processor 11 is configured to combine the text T corresponding to the picture P and the picture semantics corresponding to the picture P to generate a combined text, where the combined text includes a plurality of unit texts. Then, the processor 11 is configured to send the combined text to a language model to calculate a plurality of unit text vectors corresponding to the unit texts. Finally, the processor 11 is configured to combine the unit text vectors corresponding to unit texts to generate the readability feature.

In some embodiment, the readability includes a readability score. The readability score can be a value with a range limit (e.g.,: a minimum value of 0, and a maximum value of 1). The value can be expressed in multiple digits (e.g.,: 0.9998), and the value represents a degree of readability.

For example, in educational applications, teachers can predict the readability of a text (i.e., the data to be determined JD) according to text readability prediction device 1. The processor 11 is configured to predict that the readability score of the text is 0.1. Since the value of the readability score is close to 0, the text is relatively easy to read. Therefore, the teacher determines that the text is more suitable for lower grade students to read.

Specifically, the processor 11 is configured to send the readability feature to the readability model RM to calculate the readability score corresponding to the data to be determined JD.

In some embodiment, the processor 11 is configured to train a prediction model (e.g.: linear regression model, decision tree regression model and other regression models) according to a plurality of historical readability features and a plurality of historical readability scores corresponding to the historical readability features to generate the readability model RM.

It should be noted that the historical readability features are generated by the processor 11 according to a plurality of pieces of historical training data. For example, the pieces of historical training data can include a plurality of historical texts. In some embodiment, the pieces of historical training data can further include a plurality of historical pictures and a plurality of historical picture semantics corresponding to the historical pictures.

It should be noted that the text readability prediction device 1 can be communicatively connected to a cloud database, where the cloud database is configured to store the pieces of historical training data.

Specifically, the processor 11 is configured to train a prediction model according to a plurality of historical readability features and a plurality of historical readability scores corresponding to the historical readability features to generate readability model RM.

In some embodiment, the readability can be one of a plurality of readability classification levels. For example, the readability classification levels can be composed of different school grades (e.g.: first grade, second grade, . . . , twelfth grade), or can be composed of different age ranges (e.g.,: 0-3 years old, 3-6 years old, . . . , 15-18 years old).

For example, in educational applications, teachers can predict the readability of a text (i.e., the data to be determined JD) according to text readability prediction device 1. The processor 11 is configured to predict that the readability classification level of the text is “0-3 years old”. Therefore, the teacher determines that the text is more suitable for children aged 0 to 3 years old.

Specifically, the processor 11 is configured to send the readability feature to the readability model RM to predict a first readability classification level corresponding to the data to be determined JD, where the first readability classification level is one of the readability classification levels.

In some embodiment, the processor 11 is configured to train a prediction model (e.g.: SVM, Bayes classifier and other classification models) according to a plurality of historical readability features and a plurality of historical readability classification levels corresponding to the historical readability features to generate the readability model RM.

Specifically, the processor 11 is configured to train a prediction model according to a plurality of historical readability features and a plurality of historical readability classification levels corresponding to the historical readability features to generate the readability model RM.

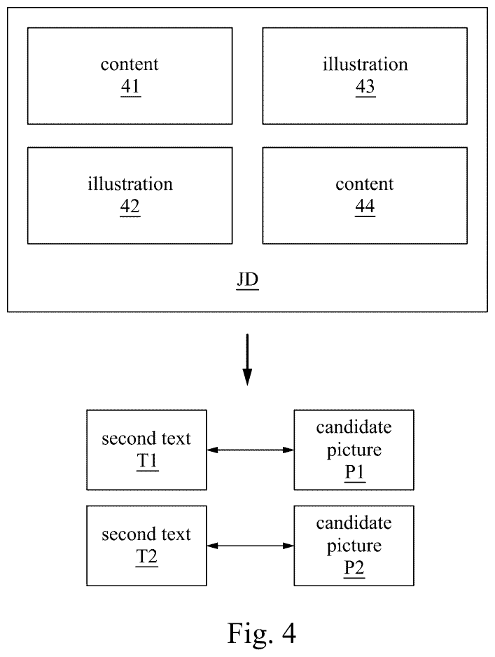

In some embodiment, the processor 11 is configured to analyze the data to be determined JD to determine whether the pieces of object data in the data to be determined JD includes information such a plurality of texts and a plurality of illustrations. For example, please refer to a data segmentation diagram in FIG. 4. As shown in FIG. 4, the data to be determined JD includes a text 41, a text 44, an illustration 42 and an illustration 43. The processor 11 is configured to segment the illustration 42 from the data to be determined JD as a candidate picture P1, segment the illustration 43 as a candidate picture P2, segment the text 41 as a second text T1, and segment the text 44 as a second text T2.

Then, the processor 11 is configured to determine corresponding relationship between the candidate pictures P1, P2 and the second texts T1, T2. For example, the processor 11 can be configured to calculate a correlation between properties of the candidate pictures P1, P2 and the second texts T1, T2, and determine, according to the correlation that the candidate picture P1 corresponds to the second text T1, and the candidate picture P2 corresponds to the second text T2.

It should be noted that tag values of the candidate pictures P1, P2 (or the second texts T1, T2) are generated according to an order in which the processor 11 is configured to perform segmentation of the candidate pictures (or the second texts). For example, the first candidate picture segmented by the processor 11 is the candidate picture P1, and the second candidate picture segmented by the processor 11 is the candidate picture P2. In other words, the candidate picture P1 does not necessarily correspond to the second text T1, and the candidate picture P2 does not necessarily correspond to the second text T2. The corresponding relationship is calculated by the processor 11 between the properties of the candidate pictures P1, P2 and the second texts T1, T2, and the corresponding relationship is determined according to the correlation.

It should be noted that calculation of correlation can be implemented in various ways. For example, the processor 11 can be configured to divide the candidate pictures P1, P2 and the second texts T1, T2 in the data to be determined JD into different blocks, calculate an area occupied by each of the blocks, and calculate the similarity between the areas of the candidate pictures P1, P2 and the second texts T1, T2 as a correlation. For another example, the processor 11 can be configured to calculate distances between center points of the blocks as a correlation.

For another example, the processor 11 is configured to simultaneously use the similarity between the areas and the distance between the center points, or further use any property that can describe the blocks, and calculate the correlation between the candidate pictures P1, P2 and the second texts T1, T2 according to a data association algorithm (e.g., Apriori algorithm, FP-Growth algorithm, Hungarian algorithm, etc.), and then determine their corresponding relationship.

Then, the processor 11 is configured to send a prompt, the candidate picture P1 and the second text T1 corresponding to the candidate picture P1, the candidate picture P2 and the second text T2 corresponding to the candidate picture P2 to the at least one multimodal large language model MLLM1, MLLM2, . . . , MLLMn to generate a candidate picture semantics corresponding to the candidate picture P1 and a candidate picture semantics corresponding to the candidate picture P2. The prompt is configured to indicate a generated type (e.g.,: the format, the tone, the word difficulty, the language, etc) of the picture semantics corresponding to the candidate picture P1 and the picture semantics corresponding to the candidate picture P2.

Finally, the processor 11 is configured to combine the second text T1, the second text T2, candidate picture semantics corresponding to the candidate picture P1 and the candidate picture semantics corresponding to the candidate picture P2 to generate a readability feature. The processor 11 is configured to send the readability feature to the readability model RM, and predict the readability of the data to be determined JD according to the readability model RM.

It should be noted that the processor 11 is configured to combine (e.g.: concatenate) the second texts T1, T2 and the candidate pictures P1, P2 corresponding to the candidate picture semantics to generate a combined text, and the combined text is composed of unit texts (e.g.: a sentence is composed of a plurality of words). Then, unit text vectors of the unit texts are calculated through a language model and the unit text vectors are combined to generate the readability feature.

Specifically, the processor 11 is configured to segment a plurality of candidate pictures P1, P2 and second texts T1, T2 corresponding to the candidate pictures P1, P2 from the data to be determined JD, where the candidate pictures P1, P2 include the picture P. Then, the processor 11 is configured to send the prompt, the candidate pictures P1, P2 and the second texts T1, T2 corresponding to the candidate pictures P1, P2 to the at least one multimodal large language model MLLM1, MLLM2, . . . , MLLMn to generate a plurality of candidate picture semantics corresponding to the candidate pictures P1, P2, where the prompt is configured to indicate a generated type of the candidate picture semantics. Finally, the processor 11 is configured to send the readability feature to the readability model RM to predict the readability corresponding to the data to be determined JD, where the readability feature is generated according to the second texts T1, T2 corresponding to the candidate pictures P1, P2 and the candidate picture semantics corresponding to the candidate pictures P1, P2.

Based on the aforementioned embodiments, the text readability prediction device 1 provided by the present disclosure is configured to segment a picture and a text corresponding to the picture from the data to be determined. Then, the present disclosure is configured to generate a picture semantics corresponding to the picture according to the multimodal large language model. Finally, the present disclosure is configured to predict the readability of the data to be determined based on transmitting the readability feature to readability model. The present disclosure is configured to generate a picture semantics corresponding to the picture through a multimodal large language model and combine the text and the picture semantics. Therefore, a technology provided by the present disclosure increases a comprehensive understanding ability of the readability prediction device 1 for text and pictures, and also improves an accuracy of readability prediction.

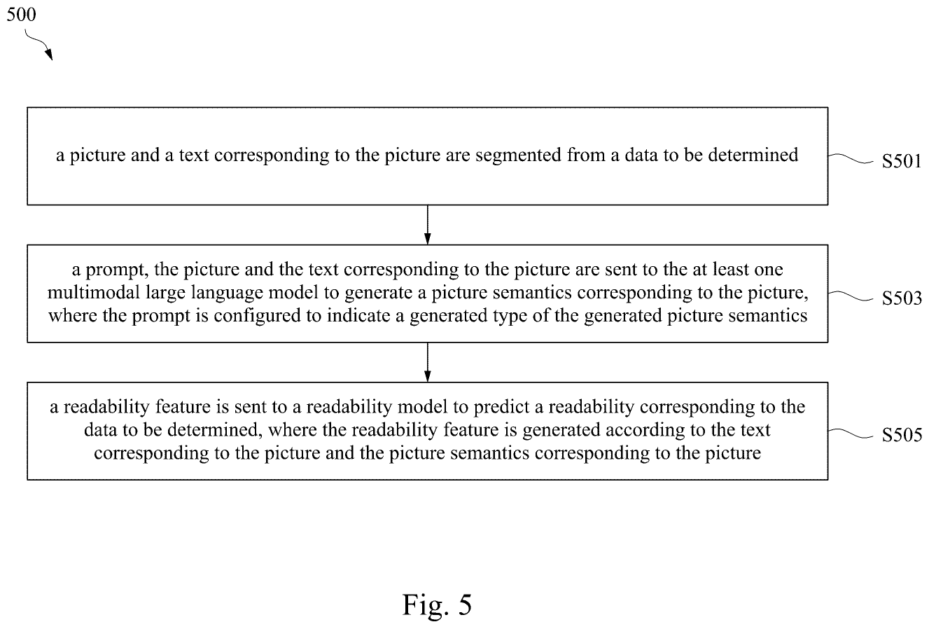

A second embodiment of the present disclosure is a text readability prediction method, flow chart of which is depicted in FIG. 5. The text readability prediction method 500 is adapted to an electronic device, such as the text readability prediction device 1 in the first embodiment. The electronic device is configured to store at least one multimodal large language model and a readability model. The text readability prediction method 500 performs readability prediction through steps S501 to S505.

First, in step S501, the electronic device is configured to segment a picture and a text corresponding to the picture from a data to be determined.

Then, in step S503, the electronic device is configured to send a prompt, the picture and the text corresponding to the picture to the at least one multimodal large language model to generate a picture semantics corresponding to the picture, wherein the prompt is configured to indicate a generated type of the generated picture semantics.

Finally, in step S505, the electronic device is configured to send a readability feature to a readability model to predict a readability corresponding to the data to be determined, where the readability feature is generated according to the text corresponding to the picture and the picture semantics corresponding to the picture.

In some embodiment, the data to be determined includes a plurality of pieces of object data, and a step of segmenting the picture and the text corresponding to the picture from the data to be determined further include following steps of: analyzing the pieces of object data on the data to be determined to generate a data tag corresponding to each of the pieces of object data; selecting a plurality of pieces of target object data corresponding to a plurality of target data tags from the pieces of object data according to the target data tags of the data tags, wherein the target data tags include a picture tag and a text tag; and segmenting the pieces of target object data from the pieces of object data to serve as the picture and the text corresponding to the picture.

In some embodiment, the at least one multimodal large language model at least include a first large language model and a second large language model, and the text readability prediction method 500 further include following steps of: sending the prompt, the picture and the text corresponding to the picture to the first large language model to generate a first candidate picture description corresponding to the picture; sending the prompt, the picture and the text corresponding to the picture to the second large language model to generate a second candidate picture description corresponding to the picture; and combining the first candidate picture description corresponding to the picture and the second candidate picture description to generate the picture semantics corresponding to the picture.

In some embodiment, the readability feature is generated according to following steps of: combining the text corresponding to the picture and the picture semantics corresponding to the picture to generate a combined text, where the combined text comprises a plurality of unit texts; sending the combined text to a language model to calculate a plurality of unit text vectors corresponding to the unit texts; and combining the unit text vectors corresponding to the unit texts to generate the readability feature.

In some embodiment, the readability includes a readability score, and the step of predicting the readability corresponding to the data to be determined further includes following steps of: sending the readability feature to the readability model to calculate the readability score corresponding to the data to be determined.

In some embodiment, the readability model is generated according to following steps: training a prediction model according to a plurality of historical readability features and a plurality of historical readability scores corresponding to the historical readability features to generate the readability model.

In some embodiment, the readability includes one of a plurality of readability classification levels, and the step of predicting the readability corresponding to the data to be determined further includes following steps of: sending the readability feature to the readability model to predict a first readability classification level corresponding to the data to be determined, where the first readability classification level is one of the readability classification levels.

In some embodiment, the readability model is generated according to following steps: training a prediction model according to a plurality of historical readability features and a plurality of historical readability classification levels corresponding to the historical readability features to generate the readability model.

In some embodiment, the text readability prediction method 500 further includes following steps of: segmenting a plurality of candidate pictures and a second text corresponding to each of the candidate pictures from the data to be determined, where the candidate pictures comprise the picture; sending the prompt, the candidate pictures and the second text corresponding to each of the candidate pictures to the at least one multimodal large language model to generate a plurality of candidate picture semantics corresponding to the candidate pictures, where the prompt is configured to indicate a generated type of the candidate picture semantics; and sending the readability feature to the readability model to predict a readability corresponding to the data to be determined, where the readability feature is generated according to the second text corresponding to each of the candidate pictures and the candidate picture semantics corresponding to the candidate pictures.

In addition to the above steps, the second embodiment can also execute all operations and steps of the readability prediction device 1 described in the first embodiment, which has the same functions, and achieves the same technical effects. A person having ordinary knowledge in the technical field to which the present invention belongs can directly understand how the second embodiment performs these operations and steps based on the above-mentioned first embodiment, has the same functions, and achieves the same technical effects, and detail repetitious descriptions are omitted here.

Based on the aforementioned embodiments, the technology provided by the present disclosure (at least including a text readability prediction device and method) is to segment a picture and a text corresponding to the picture from the data to be determined. Then, the present disclosure is configured to generate picture semantics corresponding to the picture according to a multimodal large language model. Finally, the present disclosure is configured to send the readability feature to the readability model to predict a readability corresponding to the data to be determined. The present disclosure is configured to generate picture semantics of the corresponding to the picture through the multimodal large language model, and combines the text and the picture semantics. Therefore, the technology provided by the present disclosure increases a comprehensive understanding ability of a readability prediction device for text and pictures, and also improves an accuracy of readability prediction.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A text readability prediction device, comprising:
a transceiver interface, configured to receive a data to be determined;
a storage, configured to store at least one multimodal large language model and a readability model; and
a processor, electrically connected to the transceiver interface and the storage, wherein the processor is configured to perform following operations:
segmenting a picture and a text corresponding to the picture from the data to be determined;
sending a prompt, the picture and the text corresponding to the picture to the at least one multimodal large language model to generate a picture semantics corresponding to the picture, wherein the prompt is configured to indicate a generated type of the picture semantics; and
sending a readability feature to the readability model to predict a readability corresponding to the data to be determined, wherein the readability feature is generated according to the text corresponding to the picture and the picture semantics corresponding to the picture.

2. The text readability prediction device of claim 1, wherein the operation of segmenting the picture and the text corresponding to the picture from the data to be determined further comprises following operations:
analyzing a plurality of pieces of object data on the data to be determined to generate a data tag corresponding to each of the pieces of object data;
selecting a plurality of pieces of target object data corresponding to a plurality of target data tags from the pieces of object data according to the target data tags of the data tags, wherein the target data tags comprise a picture tag and a text tag; and
segmenting the pieces of target object data from the pieces of object data to serve as the picture and the text corresponding to the picture.

3. The text readability prediction device of claim 1, wherein the at least one multimodal large language model at least comprises a first large language model and a second large language model, wherein the processor is further configured to perform following operations:
sending the prompt, the picture and the text corresponding to the picture to the first large language model to generate a first candidate picture description corresponding to the picture;
sending the prompt, the picture and the text corresponding to the picture to the second large language model to generate a second candidate picture description corresponding to the picture; and
combining the first candidate picture description corresponding to the picture and the second candidate picture description to generate the picture semantics corresponding to the picture.

4. The text readability prediction device of claim 1, wherein the readability feature is generated according to following operation:
combining the text corresponding to the picture and the picture semantics corresponding to the picture to generate a combined text, wherein the combined text comprises a plurality of unit texts;
sending the combined text to a language model to calculate a plurality of unit text vectors corresponding to the unit texts; and
combining the unit text vectors corresponding to the unit texts to generate the readability feature.

5. The text readability prediction device of claim 1, wherein the readability comprises a readability score, and the operation of predicting the readability corresponding to the data to be determined further comprises following operations:
sending the readability feature to the readability model to calculate the readability score corresponding to the data to be determined.

6. The text readability prediction device of claim 5, wherein the readability model is generated according to following operation:
training a prediction model according to a plurality of historical readability features and a plurality of historical readability scores corresponding to the historical readability features to generate the readability model.

7. The text readability prediction device of claim 1, wherein the readability comprises one of a plurality of readability classification levels, and the operation of predicting the readability corresponding to the data to be determined further comprises following operation:
sending the readability feature to the readability model to predict a first readability classification level corresponding to the data to be determined, wherein the first readability classification level is one of the readability classification levels.

8. The text readability prediction device of claim 7, wherein the readability model is generated according to following operation:
training a prediction model according to a plurality of historical readability features and a plurality of historical readability classification levels corresponding to the historical readability features to generate the readability model.

9. The text readability prediction device of claim 1, wherein the processor is further configured to perform following operations:
segmenting a plurality of candidate pictures and a second text corresponding to each of the candidate pictures from the data to be determined, wherein the candidate pictures comprise the picture;
sending the prompt, the candidate pictures and the second text corresponding to each of the candidate pictures to the at least one multimodal large language model to generate a plurality of candidate picture semantics corresponding to the candidate pictures, wherein the prompt is configured to indicate a generated type of the candidate picture semantics; and
sending the readability feature to the readability model to predict a readability corresponding to the data to be determined, wherein the readability feature is generated according to the second text corresponding to each of the candidate pictures and the candidate picture semantics corresponding to the candidate pictures.

10. A text readability prediction method, adapted to an electronic device, wherein the electronic device is configured to store at least one multimodal large language model and a readability model, wherein the text readability prediction method comprises following steps of:
segmenting a picture and a text corresponding to the picture from a data to be determined;
sending a prompt, the picture and the text corresponding to the picture to the at least one multimodal large language model to generate a picture semantics corresponding to the picture, wherein the prompt is configured to indicate a generated type of the picture semantics; and
sending a readability feature to a readability model to predict a readability corresponding to the data to be determined, wherein the readability feature is generated according to the text corresponding to the picture and the picture semantics corresponding to the picture.

11. The text readability prediction method of claim 10, wherein the step of segmenting the picture and the text corresponding to the picture from the data to be determined further comprises:
analyzing a plurality of pieces of object data on the data to be determined to generate a data tag corresponding to each of the pieces of object data;
selecting a plurality of pieces of target object data corresponding to a plurality of target data tags from the pieces of object data according to the target data tags of the data tags, wherein the target data tags comprise a picture tag and a text tag; and
segmenting the pieces of target object data from the pieces of object data to serve as the picture and the text corresponding to the picture.

12. The text readability prediction method of claim 10, wherein the at least one multimodal large language model at least comprises a first large language model and a second large language model, wherein the text readability prediction method further comprises:
sending the prompt, the picture and the text corresponding to the picture to the first large language model to generate a first candidate picture description corresponding to the picture;
sending the prompt, the picture and the text corresponding to the picture to the second large language model to generate a second candidate picture description corresponding to the picture; and
combining the first candidate picture description corresponding to the picture and the second candidate picture description to generate the picture semantics corresponding to the picture.

13. The text readability prediction method of claim 10, wherein the readability feature is generated according to following step of:
combining the text corresponding to the picture and the picture semantics corresponding to the picture to generate a combined text, wherein the combined text comprises a plurality of unit texts;
sending the combined text to a language model to calculate a plurality of unit text vectors corresponding to the unit texts; and
combining the unit text vectors corresponding to the unit texts to generate the readability feature.

14. The text readability prediction method of claim 10 wherein the readability comprises a readability score, and the step of predicting the readability corresponding to the data to be determined further comprises:
sending the readability feature to the readability model to calculate the readability score corresponding to the data to be determined.

15. The text readability prediction method of claim 14, wherein the readability model is generated according to following operation:
training a prediction model according to a plurality of historical readability features and a plurality of historical readability scores corresponding to the historical readability features to generate the readability model.
